(19) United States
(12) Patent Application Publication
(10) Pub. No.: US 2007/0028855 A1
(43) Pub. Date: Feb. 8, 2007

(54) Connectable lead

(76) Inventor: Gregory W. Mathis, Los Altos, CA (US)

Correspondence Address: GREENBERG TRAURIG LLP, 2450 COLORADO AVENUE, SUITE 400E, SANTA MONICA, CA, 90404, US

(21) Appl. No.: 11/199,939

(22) Filed: Aug. 8, 2005

(51) Int. Cl. A01K 27/00

(52) U.S. Cl. 119/795

(57) ABSTRACT

The disclosure relates to a connectable lead including a front lead portion with a collar clip, an adaptor, and a rear end portion with a handle. Furthermore, a method and apparatus for repairing a broken or severed lead is disclosed. The user can insert the lead's severed end into an adaptor which is attached to a front lead portion and collar clip.

### BACKGROUND

1. Field

This disclosure relates to a connectable lead and a method and apparatus for replacing and/or repairing a broken lead.

2. General Background

Leashes also known as leads are necessary for any pet owner. Unfortunately, leashes may break and can become severed for any number of reasons such as the pet chewing through the lead or through the normal course of wear and tear. Often, owners would rather repair the broken lead than replace the entire lead. This may be due to cost or because the user is simply accustomed to his or her lead handle. Thus, there is a need for a device which can seamlessly repair a severed lead with minimal cost and bulk while allowing the user to keep the original handle.

A leash and its design can have function such as a dual lead for two dogs or it may make a statement about a user or pet. Pet owners who require multiple functions or desire alternative designs may have multiple leashes based on these color, design, or function needs.

### SUMMARY

Generally, the present disclosure relates to a connectable lead and a method and apparatus for replacing and/or repairing a broken lead. In one embodiment of the present disclosure, is a connectable lead having a front lead portion with a first end and a second end, a rear lead portion with a first end and a second end, and an adaptor having a channel and a slot.

Further, the first end of the front lead portion is connectable to a collar clip and the second end of said first lead portion is attached (looped, threaded through) to the slot. Also, the first end of the rear lead portion is securable within the channel and the second end of the rear lead portion has a handle through which a lead is formed by connecting the front lead portion and the rear lead portion to the adaptor.

Another embodiment is a method for repairing a broken lead including the steps of forming a knotted end from a severed end of the broken lead, inserting the knotted end into a channel of an adaptor, and securing said knotted end within said channel. Further, the adaptor includes a channel, a slot, and a front lead portion attached to a collar clip.

In one exemplary embodiment, the user may wish to repair a torn or broken retractable lead instead of replacing the entire retractable lead. Thus, the user can take the severed or broken end of the lead and form a knot. Next, the user can insert and secure the knotted end into a channel of an adaptor. Because the adaptor also includes a front lead portion attached to a collar clip, once the user secures the severed end into the adaptor, the user now has a complete and repaired lead, without having to discard the original retractable handle.

Another embodiment is an apparatus for repairing a broken lead. The apparatus includes an adaptor having a channel for receiving the broken end of the lead and a slot. The apparatus also includes a front lead portion having first and second ends. Wherein the first end of the front lead portion is attached to a collar clip and the second end of the front lead portion is attached through or to the slot of the adaptor.

### DRAWINGS

The features of the invention believed to be novel are set forth with particularity in the appended claim. The invention itself, however, both as to configuration, and method of operation, and the advantages thereof, may be best understood by reference to the following descriptions taken in conjunction with the accompanied drawings.

FIG. 1 illustrates a top view of a connectable lead one exemplary implementation.

FIG. 2 illustrates a perspective view of a connectable lead of one exemplary implementation.

FIG. 3 illustrates a front view a connectable lead of one exemplary implementation.

FIG. 4 illustrates a side view a connectable lead of one exemplary implementation.

FIG. 5 illustrates a top view of a connectable lead of one exemplary implementation.

FIG. 6 illustrates a top view of a connectable lead of one exemplary implementation.

FIG. 7 illustrates a top view of a connectable lead of one exemplary implementation.

FIG. 8 illustrates a side view of a connectable lead of one exemplary implementation.

### DETAILED DESCRIPTION

A connectable lead, a method for repairing a severed lead, and its exemplary implementations are now described with reference to examples which are not to be considered as limiting.

One exemplary implementation of the connectable lead is illustrated in FIG. 2. The connectable lead 200 includes a front lead portion 201 having a first end 202 and a second end 203, a rear lead portion 204 having a first end 206 and a second end 207, a handle 208, and an adaptor 209.

The first end 202 of the front lead portion 201 may be connected to a clip 210 for attaching to a collar. The clip 210 may be rotatable or unyielding or any form of clip useful for attaching the first end 202 of the front lead portion 201 to a pet's collar. Furthermore, the first end 202 of the front lead portion 201 may be connected to another device useful for attaching the lead to a pet's collar.

The front lead portion 201 and the rear lead portion 204 may be a round rope, a flat strap, a braided rope, a cord or any design or material suitable for a lead. Furthermore, the front lead portion 201 and rear lead portion 204 may be made from materials such as nylon, leather, cotton, metal, and any other material suitable for leads. Furthermore, the front lead portion may include a buckle so that the user can vary the length of the front lead portion 201.

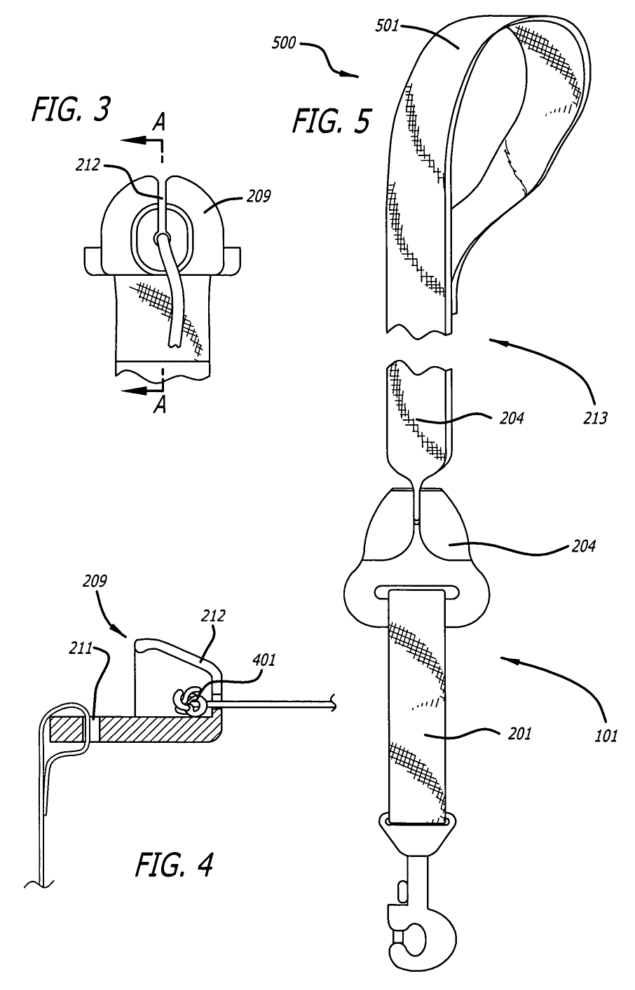

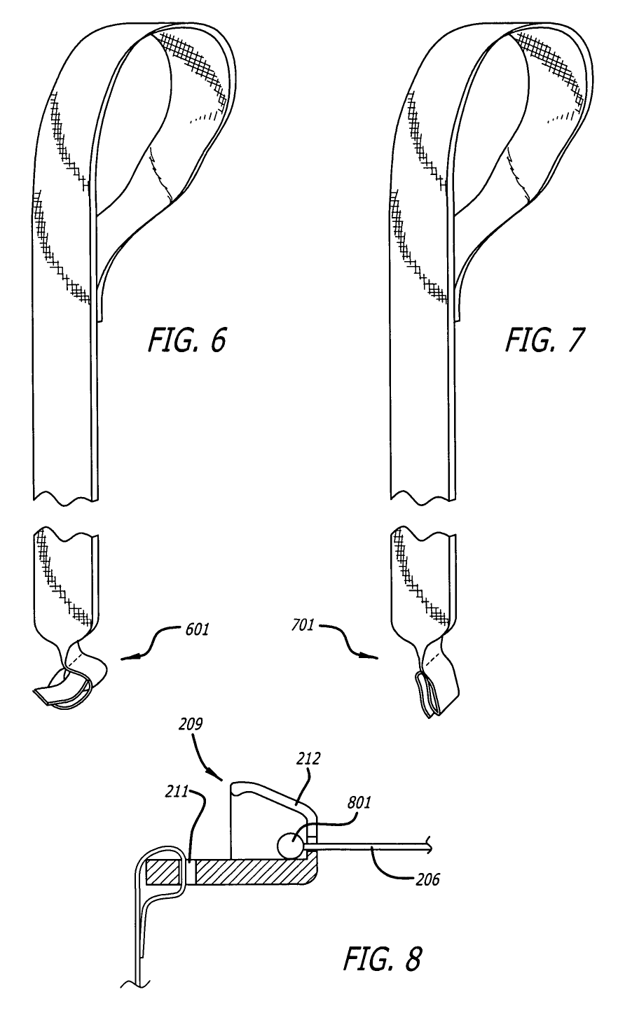

The second end 203 of the front lead portion 201 is looped, folded, laced, or otherwise threaded through or attached to the slot 211 of the adaptor 209. The first end 206 of the rear lead portion 204 is connected and held by the channel 212 of the adaptor 209. The first end 206 of the rear lead portion 204 can be knotted or otherwise constructed to form a bulbous end. The knotted or bulbous first end is sized large enough so that once inserted into channel 212 it cannot be pulled or detached from the adaptor's channel 212. Thus, the channel 212 secures the knotted or bulbous first end within the adaptor 209 and prevents the rear lead portion 204 from slipping or detaching from the adaptor 209. For example, FIG. 4 depicts a side, cut-out view of FIG. 3 at line A-A. as can be seen in FIG. 4, the lead has been threaded through the channel 212 and formed in a knot 401, so that is secured within the adaptor 209. Furthermore, FIG. 7 illustrates a folded end 701 used to secure the lead within the adaptor.

In further exemplary implementations, the first end 206 of the rear lead portion 204 is attached to a bead. As depicted in FIG. 8, the bead 801 has a mechanism for clamping or encasing the first end 206 or the rear lead portion 204. Thus, once inserted into the adaptor's channel 212, the bead 801 prevents the lead from rear lead portion 204 from being detached or pulled out of the adaptor 209. It is contemplated that the bead could have many different shapes (geometric or non-geometric) or designs that it can hold the severed end securely within the adaptor.

As can be seen in FIG. 2, the second end 207 of the rear lead portion 204 is attached to a handle 208. FIG. 2 depicts a retractable handle 208. However it is contemplated that the handle 208 may be a loop, grip, or any other conventional lead handle. FIG. 5 illustrates a connectable lead 500 with a loop handle 501.

FIG. 2 depicts one exemplary implementation of the adaptor 209. The adaptor 209 is cup-shaped with a channel 212 and a slot 211. In other exemplary implementations, the adaptor 209 can be any other shape which acts an interface between a front lead portion which is attached to a collar clip and a rear lead portion which is attached to a handle. As depicted in FIG. 4, the channel 212 is shaped to hold the knotted 401 or bulbous end of the rear lead portion 204 so that the knotted 401 or bulbous end of the rear lead portion 204 will not slip or detach from the adaptor 209. FIG. 4 further illustrates that once the knotted 401 or bulbous end of the rear lead portion 204 is inserted into the channel 212 of the adaptor 209, it cannot be pried or detached.

The slot 211 is configured so that the second end 203 of the front lead portion 201 can be looped, laced, or otherwise threaded through or attached to the slot 211. Thus, the slot 211 provides a mechanism for attaching the front lead portion 201 to the adaptor 209.

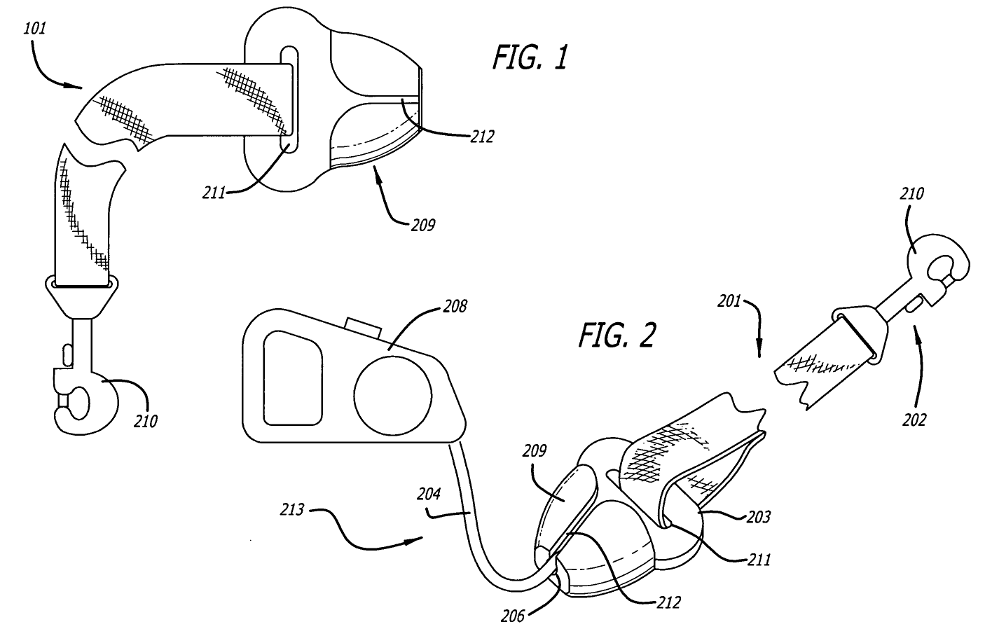

In one exemplary implementation, the slot 211 is configured to be permanently attached to the front lead portion 201. Thus, as depicted in FIG. 5, the connectable lead 200 or 500 can be characterized as having two pieces 213 and 101. In one embodiment, as depicted in as illustrated in FIG. 2, the first piece 213 includes a rear lead portion 204 which is attached to a handle 208. In one embodiment, the second piece 101, as illustrated in FIG. 1, includes an adaptor 209 attached to a front lead portion 201 which is attached to the adaptor 209.

In one embodiment, the components of each piece 213 and 101 are separate and interchangeable. Thus, each piece, 213 and 201 and the adaptor 209 can have different colors, materials, or patterns. This allows the user to be able to mix and match colors, lettering, numbering, and patterns. The patterns may include but are not limited to, stars and stripes, holiday décor, logos, or trademarks. Furthermore, the pieces (213 and 101) or adaptor 209 can be glow-in-the-dark, reflective. Many other types of embellishments are contemplated. For example, the front and rear lead portions 201, 204, and the adaptor 209 can have different lettering or numbering indicating the pet's name and contact information. In yet another example, the adaptor can be colored white, the rear lead portion and handle can be colored blue, and the front lead portion 201 can be colored red.

In one exemplary implementation, as depicted in FIG. 1, the second piece 101 may be used as an apparatus to change, alter and/or repair a severed or broken lead. The second piece 101 acts as an interface between the broken lead and the pet's collar. The second piece 101 includes the adaptor 209 and a front lead portion 201 with a collar clip 210. By attaching the lead's severed end into the channel 212 of the adaptor 209, the user can create a new and complete lead. In other words, once the user attaches the lead's severed end into the adaptor 209, the user can form a complete lead with a handle and collar clip. Thus, the second piece 101 allows the user to salvage the lead's handle and the portion of the lead connected to the handle.

For example, typically users who have more costly handles, such as a retractable handle, do not want have to replace the entire lead simply because the end has been severed or broken.

Thus, the second piece 101 may be used as an apparatus to change, alter and/or repair the severed or broken lead.

Accordingly, a method for repairing a broken or severed lead using the second piece 101 is disclosed. In order to repair the broken lead, the user can knot or tie the severed end of the leash. Once the knot 401 is formed, the user inserts the knot 401 into the channel 212 of the adaptor 209. Then, the user pulls the knot 401 so that channel 212 catches and holds the knot 401 within the channel 212. (disclose other methods of holding/gripping the knot within the channel). The channel 212 is configured so as to prevent the knot 401 or lead from slipping or detaching from the adaptor 209. Once the knot 410 is secured within the channel 212, the user has a new, repaired, and complete lead.

In other exemplary implementations, the user can insert the broken or severed end into a bead or device which can clamp or grasp or encase the severed end. Then the user can insert this end into the channel. The bead or device is sized so that it cannot be pulled or pried from the adaptor's channel.

While the apparatus and method have been described in terms of what are presently considered to be the most practical and preferred exemplary implementations, it is to be understood that the disclosure need not be limited to the disclosed exemplary implementations. It is tended to cover various modifications and similar arrangements included within the spirit and scope of the claims, the scope of which should be accorded the broadest interpretation so as to encompass all such modifications and similar structures. The present disclosure includes any and all exemplary implementations of the following claims.

1. A connectable lead comprising:
a front lead portion having a first end and a second end;
a rear lead portion having a first end and a second end; and
an adaptor having a channel and a slot;
wherein said first end of said front lead portion is connectable to a collar clip, wherein said second end of said first lead portion is attached to said slot;
wherein said first end of said rear lead portion is securable within said channel;
wherein said second end of said rear lead portion has a handle;
through which a lead is formed by connecting said front lead portion and said rear lead portion to said adaptor.

2. A method for repairing a broken lead comprising of:
forming a knotted end from a severed end of said broken lead;
inserting said knotted end into a channel of an adaptor; wherein said adaptor includes a channel, a slot, and a front lead portion attached to a collar clip, and
securing said knotted end within said channel.

3. An apparatus for repairing a broken lead comprising of:
an adaptor having a channel for receiving said broken end and a slot;
a front lead portion having a first end and a second end, wherein said first end is attached to a collar clip,
through which said second end is attached through said slot.
